(19) United States
(12) Patent Application Publication
(10) Pub. No.: US 2017/0245204 A1
(43) Pub. Date: Aug. 24, 2017

(54) SYSTEMS AND METHODS FOR PRIORITIZING CHANNEL SCANNING

(71) Applicant: QUALCOMM Incorporated, San Diego, CA (US)

(72) Inventor: Gaurav Kumar, San Diego, CA (US)

(21) Appl. No.: 15/048,850

(22) Filed: Feb. 19, 2016

(51) Int. Cl. H04W 48/16; H04W 24/08; H04W 4/00

(52) U.S. Cl. CPC H04W 48/16; H04W 4/008; H04W 24/08; H04W 84/12

(57) ABSTRACT

A method for Bluetooth low energy (BLE) advertising channel assessment by a wireless communication device is described. The method includes detecting interference on one or more of a plurality of BLE advertising channels. The method also includes determining a BLE scan order in which the BLE advertising channels are selected for scanning based on the detected interference. The method further includes scanning the BLE advertising channels according to the determined BLE scan order.

### TECHNICAL FIELD

The present disclosure relates generally to communications. More specifically, the present disclosure relates to systems and methods for prioritizing channel scanning.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices communicate with other electronic devices. These electronic devices may transmit and/or receive electromagnetic signals. For example, a smartphone may transmit signals to and/or receive signals from another device (e.g., a laptop computer, an electronics console in a vehicle, a wireless headset, etc.). In another example, a wireless headset may transmit signals to and/or receive signals from another device (e.g., a laptop computer, a game console, a smartphone, etc.).

However, particular challenges arise in wireless communications. For example, some wireless devices may perform scans on certain channels to detect the presence of other wireless devices. However, these channels may experience interference due to other wireless communication technologies. Therefore, systems and methods to prioritize channel scanning in the presence of interference may be beneficial.

### SUMMARY

A method for Bluetooth low energy (BLE) advertising channel assessment by a wireless communication device is described. The method includes detecting interference on one or more of a plurality of BLE advertising channels. The method also includes determining a BLE scan order in which the BLE advertising channels are selected for scanning based on the detected interference. The method further includes scanning the BLE advertising channels according to the determined BLE scan order.

Determining the BLE scan order may include determining that a first BLE advertising channel of the BLE advertising channels has no detected interference or interference below a predetermined interference threshold. The first BLE advertising channel may be selected to be the first channel in the BLE scan order.

Detecting the interference may include detecting a wireless local area network (WLAN) channel that overlaps one or more of the BLE advertising channels. Detecting the interference may include determining whether a given BLE advertising channel is in a channel mask of BLE channels that overlap with a WLAN channel used by the wireless communication device.

Detecting the interference may include determining whether a given BLE advertising channel has a detected energy above a predetermined threshold. Detecting the interference may include determining whether a BLE advertising channel is in a bad channel assessment list that includes one or more BLE channels with a detected energy above a bad channel threshold.

Detecting the interference may include identifying a set of contiguous interfered BLE channels that are marked bad during a bad channel assessment. A WLAN channel may be extrapolated from the set of contiguous interfered BLE channels. A given BLE advertising channel may be determined to fall within the extrapolated WLAN channel. The given BLE advertising channel that falls within the extrapolated WLAN channel may be determined to have a detected energy below a bad channel threshold.

The method may also include determining that a given BLE advertising channel is not included in either a channel mask or a bad channel assessment list. A highest order in the BLE scan order may be assigned to the given BLE advertising channel.

A wireless communication device configured for BLE advertising channel assessment is also described. The wireless communication device includes a processor and a memory in electronic communication with the processor. The processor and memory are configured to detect interference on one or more of a plurality of BLE advertising channels. The processor and memory are also configured to determine a BLE scan order in which the BLE advertising channels are selected for scanning based on the detected interference. The processor and memory are further configured to scan the BLE advertising channels according to the determined BLE scan order.

The wireless communication device may also include an antenna configured to intercept the one or more of the plurality of BLE advertising channels. The wireless communication device may further include a receiver configured to perform the scan of the BLE advertising channels according to the determined BLE scan order.

An apparatus configured for BLE advertising channel assessment is also described. The apparatus includes means for detecting interference on one or more of a plurality of BLE advertising channels. The apparatus also includes means for determining a BLE scan order in which the BLE advertising channels are selected for scanning based on the detected interference. The apparatus further includes means for scanning the BLE advertising channels according to the determined BLE scan order.

A computer-program product for BLE advertising channel assessment is also described. The computer-program product includes a non-transitory computer-readable medium having instructions thereon. The instructions include code for causing a wireless communication device to detect interference on one or more of a plurality of BLE advertising channels. The instructions also include code for causing the wireless communication device to determine a BLE scan order in which the BLE advertising channels are selected for scanning based on the detected interference. The instructions further include code for causing the wireless communication device to scan the BLE advertising channels according to the determined BLE scan order.

### BRIEF DESCRIPTION OF THE DRAWINGS

FIG. 1 is a block diagram illustrating a wireless communication device in which prioritized channel scanning may be implemented;

FIG. 2 is a flow diagram illustrating one configuration of a method for prioritizing Bluetooth low energy (BLE) advertising channel scanning;

FIG. 3 is a diagram illustrating a channel spectrum map of BLE channels;

FIG. 4 is a diagram illustrating the overlap of BLE advertising channels and wireless local area network (WLAN) channels;

FIG. 5 is a flow diagram illustrating one configuration of a method for performing a bad channel assessment;

FIG. 6 is a flow diagram illustrating one configuration of a method for performing a band-detect operation;

FIG. 7 is a diagram illustrating an example of a band-detect operation;

FIG. 8 is a flow diagram illustrating another configuration of a method for prioritizing BLE advertising channel scanning; and

FIG. 9 illustrates certain components that may be included within a wireless communication device.

### DETAILED DESCRIPTION

The systems and methods described herein may be implemented on a variety of different electronic devices. Examples of electronic devices include general purpose or special purpose computing system environments or configurations, personal computers (PCs), server computers, handheld or laptop devices, multiprocessor systems, microprocessor-based systems, programmable consumer electronics, network PCs, minicomputers, mainframe computers, distributed computing environments that include any of the above systems or devices and the like. The systems and methods may also be implemented in mobile devices such as phones, smartphones, wireless headsets, personal digital assistants (PDAs), ultra-mobile personal computers (UMPCs), mobile Internet devices (MIDs), etc. Further, the systems and methods may be implemented by battery-operated devices, sensors, etc. The following description refers to wireless communication devices for clarity and to facilitate explanation. Those of ordinary skill in the art will understand that a wireless communication device may comprise any of the devices described above as well as a multitude of other devices.

The Bluetooth wireless communication standard is typically employed for exchanging communications between fixed or mobile Bluetooth-enabled devices over short distances. In some configurations, the systems and methods disclosed herein may be applied to prioritize the scanning of BLE advertising channels. LE refers to the “Low Energy” extension of the Bluetooth standard. The BLE extension is focused on energy-constrained applications such as battery-operated devices, sensor applications, etc. The following description uses terminology associated with the Bluetooth and Bluetooth LE standards. Nevertheless, the concepts are applicable to other technologies and standards that involve modulating and transmitting digital data. Accordingly, while some of the description is provided in terms of Bluetooth standards, the systems and methods disclosed herein may be implemented more generally in wireless communication devices that may not conform to Bluetooth standards.

A BLE device may comprise a transmitter, a receiver, or both a transmitter and a receiver. A BLE device may also use a frequency-hopping transceiver to combat interference and fading.

BLE systems operate in the unlicensed 2.4 gigahertz (GHz) Industrial-Scientific-Medical (ISM) band at 2.400-2.4835 GHz (2400-2483.5 megahertz (MHz)). The operating frequency bands of BLE systems are illustrated in Equation (1). In particular, BLE systems use forty radio frequency (RF) channels with center frequencies (f) as illustrated in Equation (1).

f=2402+k×2 MHz;k=0, . . . ,39 (1)

As part of the device discovery and connection setup procedure, a remote BLE device may transmit advertisement packets on advertising channels. A BLE device may perform periodic scans on the advertising channels to detect these advertisement packets.

The 2.4 GHz unlicensed band has many technologies that operate simultaneously. For example, wireless local area network (WLAN) is popular and presents a major source of interference for BLE operations. The BLE advertising channels overlap with one or more WLAN channels. This channel overlap and interference may reduce the probability of detecting advertisement packet on an advertising channel where the interference exists. This in general has an impact where time taken to discover a BLE peripheral is longer. This impact may be noticeable to a user and may cause an inconsistent and bad user experience.

The systems and methods disclosed herein provide for prioritizing channel scanning with BLE communication. A wireless communication device may determine a BLE scan order in which BLE advertising channels are selected for scanning based on a detected interference.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

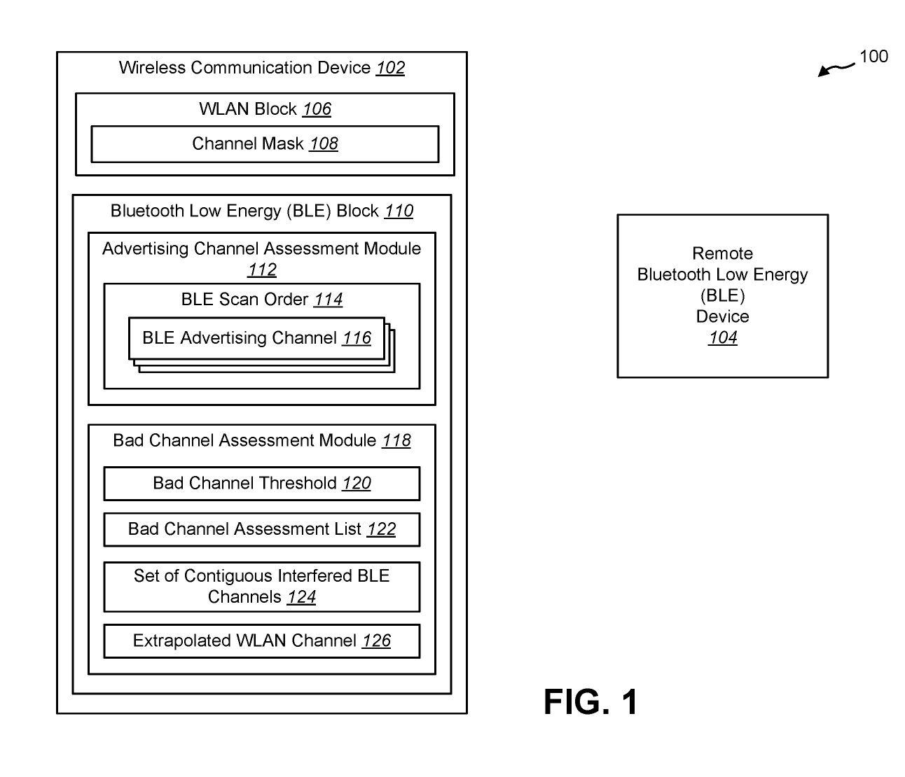

FIG. 1 is a block diagram illustrating a wireless communication device 102 in which prioritized channel scanning may be implemented. The wireless communication device 102 may be included in a wireless communication system 100. Wireless communication systems 100 are widely deployed to provide various types of communication content such as voice, data and so on.

Communications in the wireless system may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may operate in accordance with one or more standards. Examples of these standards include Bluetooth (e.g., Institute of Electrical and Electronics Engineers (IEEE) 802.15.1), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc. Accordingly, the wireless communication device 102 may communicate with the remote BLE device 104 using a communication protocol such as Bluetooth LE in some configurations.

In some configurations, the wireless communication system 100 may be a multiple-access system capable of supporting communication with multiple wireless communication devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO) systems, single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

In LTE and UMTS, a wireless communication device 102 may be referred to as a “user equipment” (UE). In 3GPP Global System for Mobile Communications (GSM), a wireless communication device may be referred to as a “mobile station” (MS). The wireless communication device 102 may be referred to as and/or may include some or all of the functionality of a UE, MS, terminal, an access terminal, a subscriber unit, a station, etc. Examples of the wireless communication device 102 include cellular phones, smartphones, wireless headsets, wireless speakers, personal digital assistants (PDAs), wireless devices, electronic automobile consoles, gaming systems, wireless controllers, sensors, wireless modems, handheld devices, laptop computers, Session Initiation Protocol (SIP) phones, wireless local loop (WLL) stations, etc.

The wireless communication device 102 may include a BLE block 110. With the proliferation of BLE technology, many BLE-based devices are becoming popular. Examples of devices that use BLE include wearables (e.g., fitness trackers, smartwatches) and various sensor devices. In an implementation, the wireless communication device 102 may be a smartphone that connects to one or more of these remote BLE devices 104.

In a BLE connection (e.g., a BLE connection between a wearable and a smartphone), a remote BLE device 104 (e.g., wearable device) may take up role of a BLE peripheral (and slave) and the wireless communication device 102 (e.g., smartphone) may take up role of a BLE central (and master). As part of the device discovery and connection setup procedure, the remote BLE device 104 transmits advertisement packets on BLE advertising channels 116. The wireless communication device 102 does periodic scans on the BLE advertising channels 116 to detect these advertisement packets.

In an implementation, the wireless communication device 102 may include an antenna (not shown) configured to intercept the BLE advertising channels 116. The wireless communication device 102 may also include a receiver (not shown) to perform a scan of the BLE advertising channels 116 according to a determined BLE scan order 114.

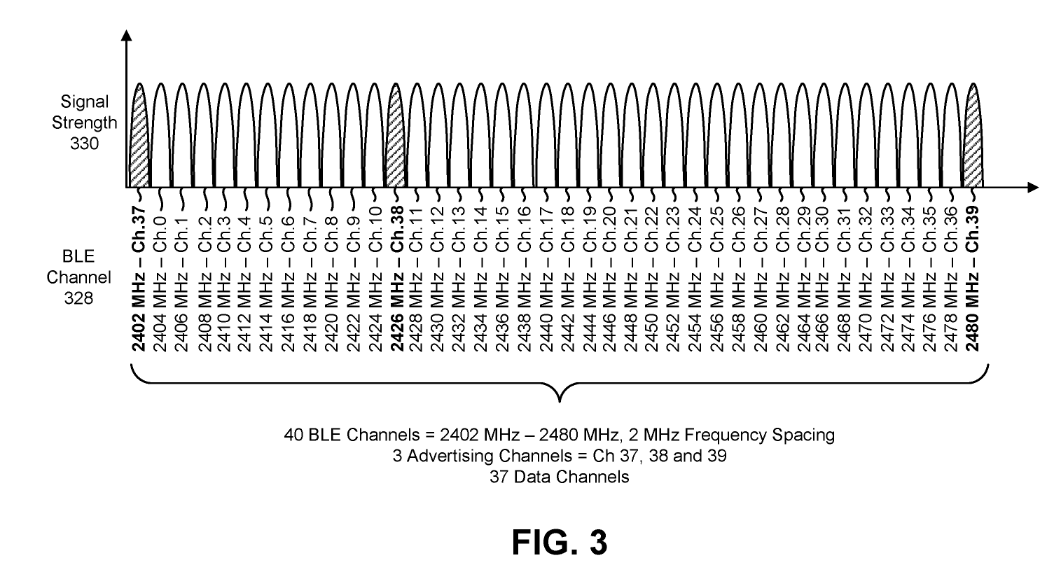

The Bluetooth specification requires BLE peripherals to transmit advertisement packets only on a select few channels. These are called BLE advertising channels 116. There are three specified BLE advertising channels 116: channel 37, 38 and 39. The channel spectrum map of FIG. 3 provides a detailed picture of how the 2.4 GHz band is broken up into BLE advertising channels 116 and BLE data channels.

When a BLE peripheral (e.g., remote BLE device 104) transmits advertisement packets, it transmits back-to-back on BLE advertising channel 37, 38 and 39. The time between each advertisement packet is generally less than or equal to 10 milliseconds (msec).

On the BLE central (e.g., wireless communication device 102), there are two governing time parameters: the scan window and scan interval. The scan window determines how long the receiver should scan on a BLE advertising channel 116 and the scan interval determines how often the scan needs to be done. The scan window and scan interval times are set by higher layers but typical value for the scan window is 0.5 sec and the scan interval is 2.0 sec.

The BLE central will scan on one BLE advertising channel 116 for the period of the scan window and then every scan interval it will move to the next BLE advertising channel 116 and so forth. The Bluetooth specification does not provide any BLE advertising channel 116 selection rules.

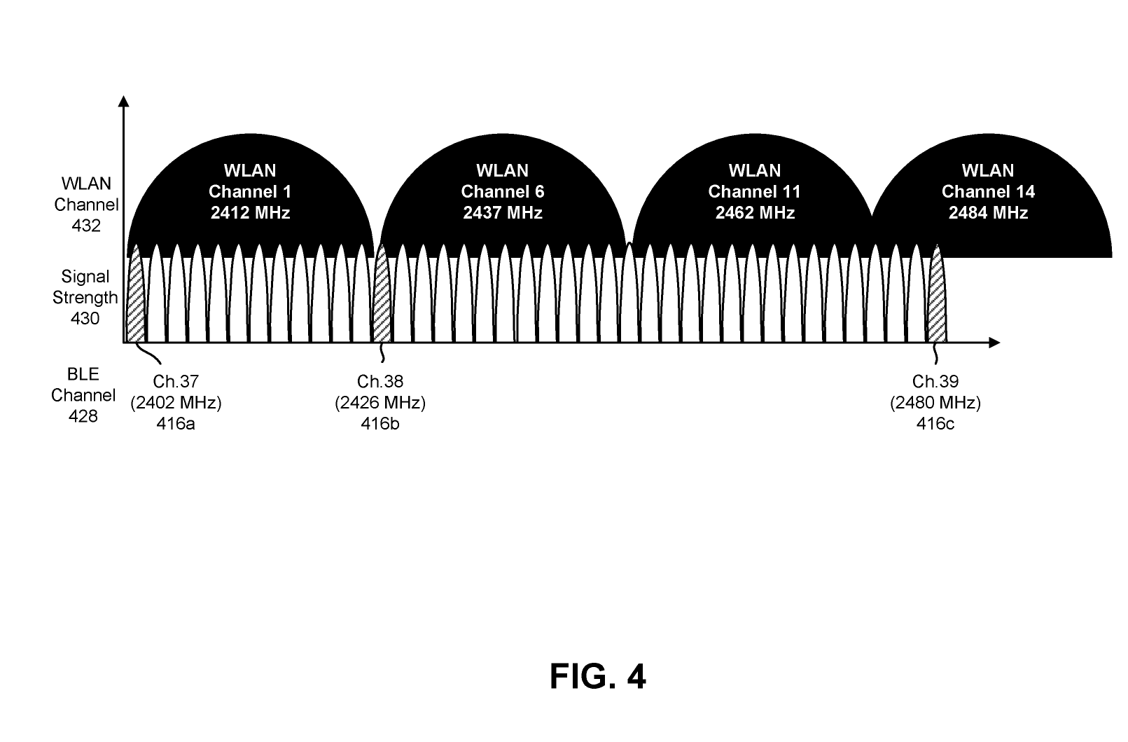

The 2.4 GHz unlicensed band has many technologies that operate simultaneously. For example, WLAN is a popular technology operating in the 2.4 GHz unlicensed band. WLAN presents a major source of interference for BLE operations. The BLE advertising channels 116 overlap with one or more WLAN channels. For example, BLE Advertising Channel 37 (2402 MHz) overlaps with WLAN Channel 1 (2412 MHz), and BLE Advertising Channel 39 (2480 MHz) overlaps with WLAN Channel 14 (2484 MHz). The overlap of the BLE advertising channels 116 and the WLAN channels is further described in connection with FIG. 4.

WLAN interference may be a more significant source of interference than interference from a Bluetooth (BT) or BLE source. With BT and BLE, frequency hopping may minimize the duration of interference. However, WLAN does not use frequency hopping. If the WLAN is communicating, the energy is present in a WLAN channel all the time that WLAN is active. Therefore, WLAN interference may be more static and persistent. It may be beneficial to detect a WLAN channel and avoid it during scanning.

Due to the above mentioned channel overlap and interference, there is a reduced probability of detecting an advertisement packet on a BLE advertising channel 116 where the interference exists. This in general has an impact where time taken to discover a BLE peripheral is longer. This is a perceptible impact that is noticeable to a user and causes an inconsistent and bad user experience. For example, in a real world scenario, if a smartphone user is trying to discover his or her smartwatch, in the presence of interference there will be a perceptible and noticeable delay to discover the smartwatch.

In some approaches, a wireless communication device 102 may detect interference on a BLE channel and avoid using that BLE channel for future operations. This approach, however, is problematic. For example, because of the dynamic nature of BLE frequency hopping, a remote BLE device 104 may transmit advertising packets on a BLE channel that formerly had interference. If a BLE advertising channel 116 is excluded from scanning due to past interference, then the wireless communication device 102 may miss an advertisement packet transmission.

The systems and methods described herein provide for prioritizing BLE advertising channel 116 scanning. The wireless communication device 102 may use a new approach to determine the BLE scan order 114 in which BLE advertising channels 116 are scanned. This new approach may be referred to as advertising channel assessment. The wireless communication device 102 may include an advertising channel assessment module 112 that implements the advertising channel assessment.

The advertising channel assessment module 112 will decide the BLE scan order 114 in which the BLE advertising channels 116 are selected for scanning based on detected interference on the BLE advertising channels 116. A BLE advertising channel 116 with no detected interference or interference below a predetermined interference threshold may be selected first for scanning. This will ensure that the probability of finding an advertisement packet from the remote BLE device 104 (e.g., BLE Peripheral) is higher than scanning that does not consider interference.

The goal of the BLE scan order 114 is to receive the advertising packet with high probability. A high probability may be achieved when a BLE advertising channel 116 is found that is not interfering (e.g., does not have interference). The wireless communication device 102 may listen on that BLE advertising channel 116 so it can get the advertising packet detected and then go on to the next stage of the connection setup.

The wireless communication device 102 may include a BLE block 110. In an implementation, the BLE block 110 may be a BT/BLE system on chip (SoC). The BLE block 110 may detect interference that exists in the 2.4 GHz band.

Two approaches may be employed to detect interference on one or more BLE advertising channels 116. In a first approach, the advertising channel assessment module 112 may receive a channel mask 108 from a WLAN block 106 of the wireless communication device 102. The wireless communication device 102 may include a WLAN block 106.

The WLAN block 106 may include a WLAN transmitter and/or receiver (not shown). When the WLAN transmitter becomes active, a channel mask 108 is generated. The channel mask 108 lists all the BLE channels that overlap with the WLAN channel being used by the wireless communication device 102. This channel mask 108 may be communicated to the BT/BLE subsystem which avoids hopping to these channels during data transfer.

The advertising channel assessment module 112 may determine whether a given BLE advertising channel 116 is in the channel mask 108 of BLE channels that overlap with a WLAN channel used by the wireless communication device 102. If a BLE advertising channel 116 is included in the channel mask 108, the advertising channel assessment module 112 may consider that BLE advertising channel 116 as interfered and may evaluate the other BLE advertising channels 116 to identify one that is not interfered. If all BLE advertising channels 116 are included in the channel mask 108, then all the BLE advertising channels 116 have interference and the BLE block 110 may initiate a scan of the BLE advertising channels 116 with the first BLE advertising channel 116 (i.e., channel 37).

In a second approach to detecting interference on one or more BLE advertising channels 116, the advertising channel assessment module 112 may perform a bad channel assessment. The BLE block 110 may include a bad channel assessment module 118 that performs the bad channel assessment. The bad channel assessment module 118 may conduct periodic bad channel assessment for the entire BLE band by reading the receive signal strength (RSSI) on each BLE channel. If the bad channel assessment module 118 detects energy above a certain pre-programmed threshold (referred to herein as the bad channel threshold 120), that BLE channel is classified as bad. This BLE channel may be added to a bad channel assessment list 122 as a bad channel. The typical time taken to sweep through the entire BLE band is about 20 slots or 12.5 msec.

In an implementation, the channels marked bad during the bad channel assessment phase are further processed to detect a WLAN band. This operation may be referred to as a band-detect. The band-detect identifies a set 124 of contiguous interfered BLE channels that are marked bad during the bad channel assessment. The bad channel assessment module 118 may then attempt to identify and construct a WLAN band. This addresses situations where the edges of the WLAN band having lower power might not be assessed as bad during the bad channel assessment.

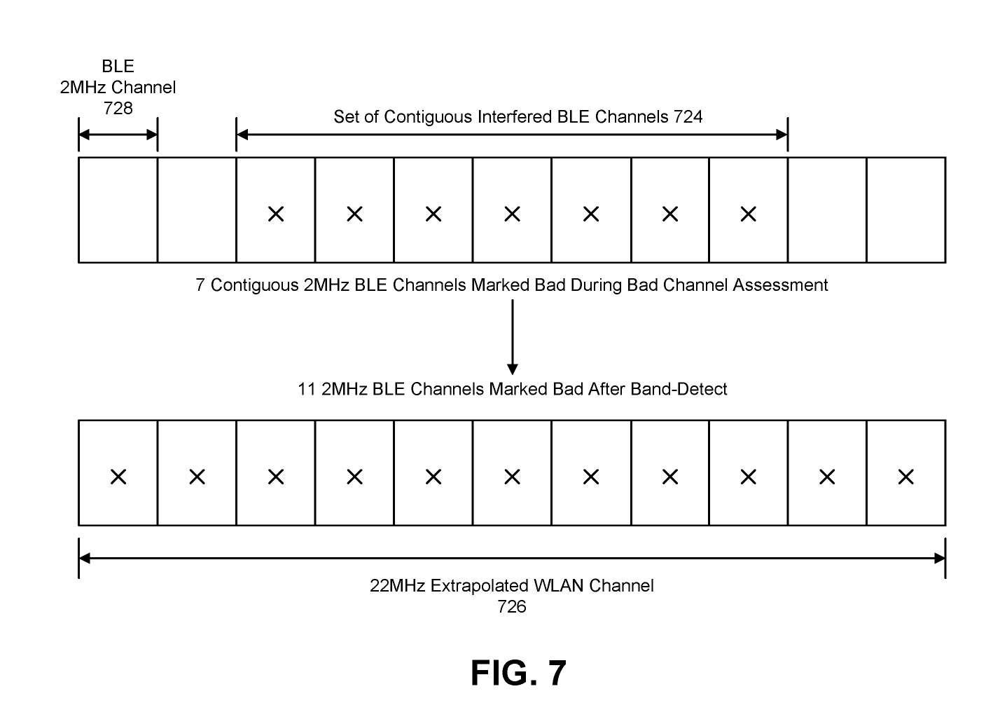

The bad channel assessment module 118 may extrapolate a WLAN channel 126 from the set 124 of contiguous interfered BLE channels. For example, the bad channel assessment module 118 may extrapolate the data from the bad channel assessment to construct the extrapolated WLAN channel 126 and mark all 2 MHz BLE channels bad that fall in that WLAN band. These additional bad BLE channels may be added to the bad channel assessment list 122. The bad channel assessment module 118 may then determine whether a given BLE advertising channel 116 falls within the extrapolated WLAN channel 126. The illustration in FIG. 7 provides more information on the band-detect operation.

The advertising channel assessment module 112 may use all the above mentioned techniques (e.g., channel mask 108 information, bad channel assessment and band-detect) to generate the BLE scan order 114. For example, the advertising channel assessment module 112 may determine whether a BLE advertising channel 116 is in the channel mask 108, the bad channel assessment list 122 or falls within the extrapolated WLAN channel 126.

A given BLE advertising channel 116 with no WLAN interference may be assigned the highest in the BLE scan order 114. In other words, the first BLE advertising channel 116 in the BLE scan order 114 may be a given BLE advertising channel 116 that is not in the channel mask 108, the bad channel assessment list or is not included in extrapolated WLAN channel 126.

The benefits of the described systems and methods include faster discovery and connection time. The wireless communication device 102 is able to discover a remote BLE device 104 like a smartwatch in a shorter time. The system 100 overall becomes more efficient by being able to prioritize scanning on a BLE advertising channel 116 that has a higher probability of detecting advertising packets. As soon the advertising packets are detected, a connection request is initiated. This may cut down the time do repeated scans on all three BLE advertising channels 116, which makes the overall discovery process more power efficient.

Additionally, the described systems and methods may provide a consistent user experience. Having the wireless communication device 102 decide and choose the best BLE advertising channel 116 to scan will ensure that user experience remains consistent across both non-interference scenarios and in the presence of interference.

Although FIG. 1 depicts a wireless communication device 102 with a WLAN block 106 and a BLE block 110, the wireless communication device 102 may comprise other components not illustrated in FIG. 1. Those skilled in the art will understand that the wireless communication device 102 of FIG. 1 has been simplified to facilitate explanation.

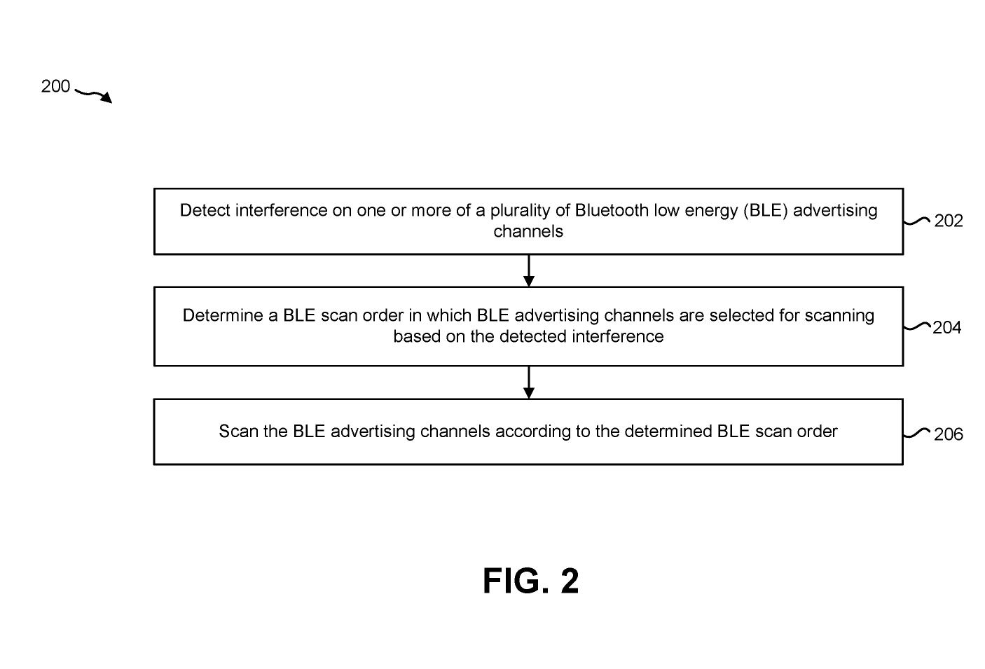

FIG. 2 is a flow diagram illustrating one configuration of a method 200 for prioritizing BLE advertising channel 116 scanning. The method 200 may be performed by a wireless communication device 102. In an implementation, the wireless communication device 102 may be configured to communicate according to BLE protocols. For example, the wireless communication device 102 may include a BLE block 110.

The wireless communication device 102 may detect 202 interference on one or more of a plurality of BLE advertising channels 116. The interference may include a WLAN channel that overlaps one or more BLE advertising channels 116. In an implementation, the wireless communication device 102 may detect 202 interference by determining whether a given BLE advertising channel 116 is in a channel mask 108 of BLE channels that overlap with a WLAN channel used by the wireless communication device 102.

The wireless communication device 102 may also detect 202 interference by determining whether a given BLE advertising channel 116 has a detected energy above a predetermined threshold. For example, the wireless communication device 102 may conduct a periodic bad channel assessment for the entire BLE band by reading the receive signal strength (RSSI) on each BLE channel. If the wireless communication device 102 detects energy above a bad channel threshold 120, that BLE channel is classified as bad. This BLE channel may be added to a bad channel assessment list 122 as a bad channel.

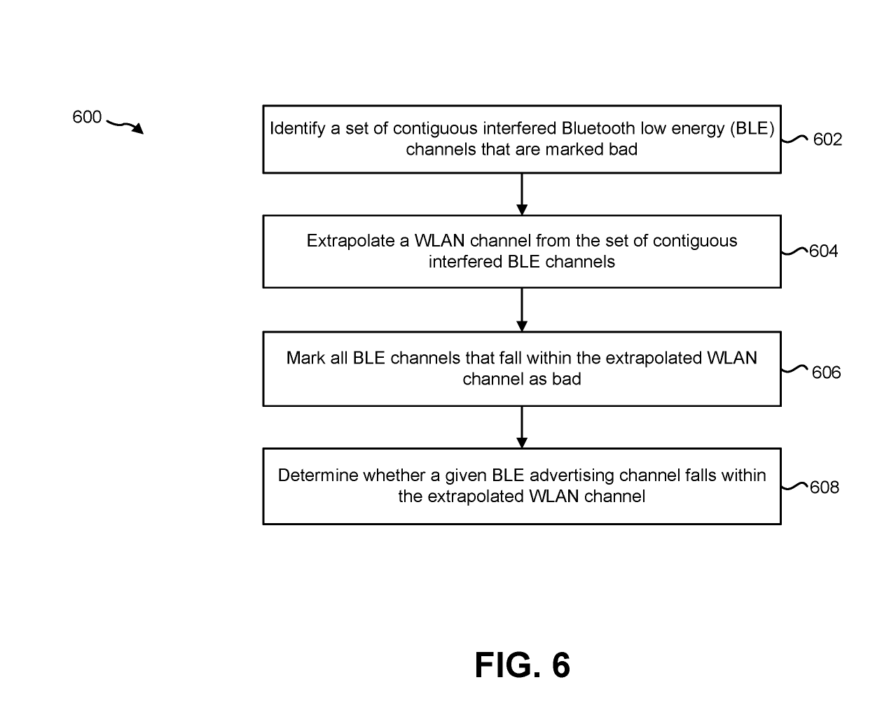

The wireless communication device 102 may also detect 202 interference by performing a band-detect operation. The wireless communication device 102 may extrapolate a WLAN channel from a set 124 of contiguous interfered BLE channels. This may be accomplished as described in connection with FIG. 6. The wireless communication device 102 may determine whether a given BLE advertising channel 116 falls within the extrapolated WLAN channel 126.

The wireless communication device 102 may determine 204 a BLE scan order 114 in which BLE advertising channels 116 are selected for scanning based on the detected interference. For example, a given BLE advertising channel 116 that is not included in either the channel mask 108 or a bad channel assessment list 122 may be assigned a highest order in the BLE scan order 114. Additionally, the wireless communication device 102 may determine whether a given BLE advertising channel 116 is within the extrapolated WLAN channel 126.

The wireless communication device 102 may scan 206 the BLE advertising channels 116 according to the determined BLE scan order 114. A first BLE advertising channel 116 in the BLE scan order 114 may have no detected interference.

FIG. 3 is a diagram illustrating a channel spectrum map of BLE channels 328. 40 BLE channels 328 are shown with their corresponding center frequencies. BLE systems operate in the unlicensed 2.4 gigahertz (GHz) Industrial-Scientific-Medical (ISM) band at 2.400-2.4835 GHz. The BLE channels 328 have a 2 MHz frequency spacing. As indicated by the signal strength 330, a BLE channel 328 is strongest at the center frequency.

In BLE, there are 40 BLE channels 328. Three BLE channels 328 are BLE advertising channels 116 (indicated in FIG. 3 by cross-hatching). These are channels 37, 38 and 39. Channel 37 has a center frequency of 2402 MHz. Channel 38 has a center frequency of 2426 MHz. Channel 39 has a center frequency of 2480 MHz. The remaining 37 BLE channels 328 are data channels.

FIG. 4 is a diagram illustrating the overlap of BLE advertising channels 416 and WLAN channels 432. The BLE channels 428 described in connection with FIG. 3 are shown with overlapping WLAN channels 432. The signal strength 430 for the BLE channels 428 and WLAN channels 432 is depicted.

WLAN operates in the 2.4 GHz unlicensed band. A WLAN channel 432 may be a 22 MHz channel. WLAN Channel 1 has a center frequency of 2412 MHz. WLAN Channel 6 has a center frequency of 2437 MHz. WLAN Channel 11 has a center frequency of 2462 MHz. WLAN Channel 14 has a center frequency of 2484 MHz.

WLAN presents a major source of interference for BLE operations. The BLE advertising channels 316 overlap with one or more WLAN channels 432. For example, BLE Advertising Channel 37 (2402 MHz) 416a overlaps with WLAN Channel 1 (2412 MHz). BLE Advertising Channel 38 (2428 MHz) 416b overlaps with WLAN Channel 6 (2437 MHz). BLE Advertising Channel 39 (2480 MHz) overlaps with WLAN Channel 14 (2484 MHz).

It should be noted that the signal strength 430 of a WLAN channel 432 is weaker at the edge of the WLAN channel 432. For example, the edge of WLAN channel 1 overlaps with BLE advertising channel 37. Therefore, situations may occur where the edges of a WLAN channel 432 with a lower power might not be assessed as bad during a bad channel assessment by the wireless communication device 102. In these scenarios, the wireless communication device 102 may perform band-detect as described above to identify whether a WLAN channel 432 interferes with a BLE advertising channel 416.

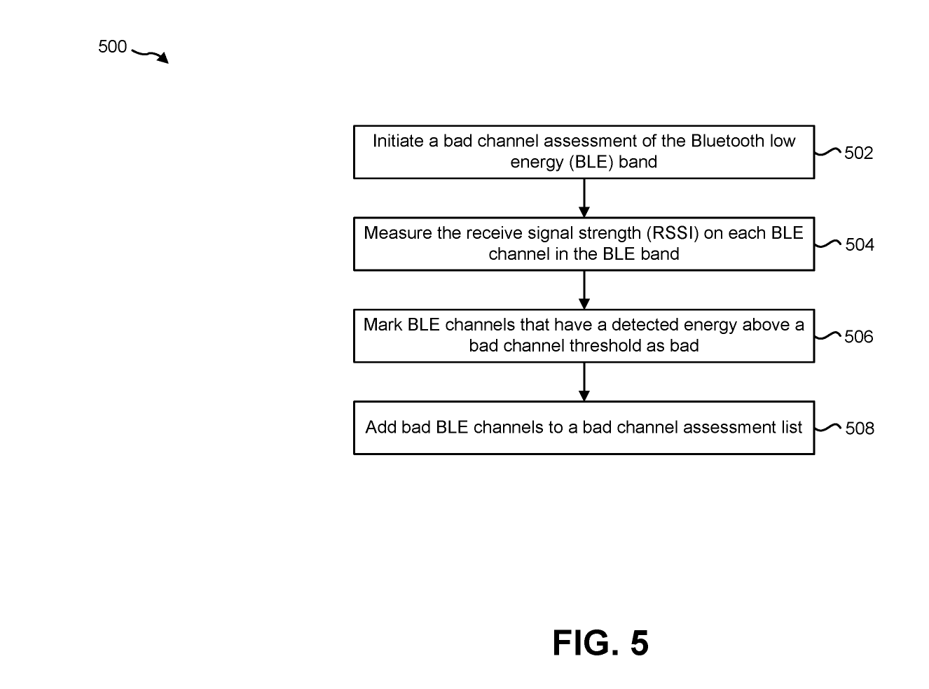

FIG. 5 is a flow diagram illustrating one configuration of a method 500 for performing a bad channel assessment. The method 500 may be performed by a wireless communication device 102.

The wireless communication device 102 may initiate 502 a bad channel assessment of the BLE band. As described above, the BLE band may include 40 BLE channels 328. The wireless communication device 102 may conduct periodic bad channel assessment for the entire BLE band.

The wireless communication device 102 may measure 504 the receive signal strength (RSSI) on each BLE channel 328 in the BLE band. The wireless communication device 102 may mark 506 BLE channels 328 that have a detected energy above a bad channel threshold 120 as bad. For example, if the RSSI of a BLE channel 328 is above the bad channel threshold 120, then that BLE channel 328 may be identified as a bad channel.

The wireless communication device 102 may add 508 the bad BLE channels 328 to a bad channel assessment list 122. Therefore, the bad channel assessment list 122 may include one or more BLE channels with a detected energy above a bad channel threshold 120.

FIG. 6 is a flow diagram illustrating one configuration of a method 600 for performing a band-detect operation. The method 600 may be performed by a wireless communication device 102.

The wireless communication device 102 may identify 602 a set 124 of contiguous interfered BLE channels that are marked bad. For example, the wireless communication device 102 may perform a bad channel assessment as described in connection with FIG. 5. The wireless communication device 102 may determine whether a BLE advertising channel 116 is in a bad channel assessment list 122 that includes one or more BLE channels 328 with a detected energy above a bad channel threshold 120.

The set 124 of contiguous interfered BLE channels may include a configurable number of contiguous interfered BLE channels. For example, the set 124 of contiguous interfered BLE channels may include 7 BLE channels 328 that are marked bad. In other words, these contiguous channels have been identified as having interference.

The wireless communication device 102 may extrapolate 604 a WLAN channel 432 from the set 124 of contiguous interfered BLE channels. The wireless communication device 102 may construct a WLAN band by adding additional BT channels to either side of the set 124 of contiguous interfered BLE channels. For example, if the set 124 of contiguous interfered BLE channels includes 7 BLE channels 328, the wireless communication device 102 may construct an extrapolated WLAN channel 126 of 22 MHz by adding three BLE channels 328 to each end of the set 124 of contiguous interfered BLE channels. An example of the WLAN channel extrapolation is described in connection with FIG. 7.

The wireless communication device 102 may mark 606 all BLE channels 328 that fall within the extrapolated WLAN channel 432 as bad. For example, the wireless communication device 102 may determine whether any additional BLE channel 328 falls within the extrapolated WLAN channel 126. The wireless communication device 102 may add these BLE channels 328 to the bad channel assessment list 122.

The wireless communication device 102 may determine 608 whether a given BLE advertising channel 116 falls within the extrapolated WLAN channel 126. If a BLE advertising channel 116 is included in the extrapolated WLAN channel 126, then this indicates that a WLAN transmission is interfering with the BLE advertising channel 116.

It should be noted that an interfered BLE advertising channel 116 may fall within the extrapolated WLAN channel 126 but has a detected energy below the bad channel threshold 120. For example, if the BLE advertising channel 116 is at the edge of a WLAN channel 432, then the interference caused by the WLAN transmission may not be detected during the bad channel assessment. In other words, the wireless communication device 102 may determine that the given BLE advertising channel 116 that falls within the extrapolated WLAN channel has a detected energy below the bad channel threshold 120. However, by constructing an extrapolated WLAN channel 126, the wireless communication device 102 may identify this interference.

The wireless communication device 102 may use this knowledge when determining the BLE scan order 114. For example, a BLE advertising channel 116 that falls within the extrapolated WLAN channel 126 may be given a lower priority for scanning than a BLE advertising channel 116 that does not fall within the extrapolated WLAN channel 126.

FIG. 7 is a diagram illustrating an example of a band-detect operation. In this example, a band of 11 BLE channels 328 is shown. Each BLE channel 728 is a 2 MHz channel. Upon performing a bad channel assessment (as described in connection with FIG. 5), seven contiguous 2 MHz BLE channels 728 are marked bad.

The wireless communication device 102 may then perform a band-detect operation to detect a WLAN channel 726. From the set 724 of seven contiguous interfered BLE channels 728, the wireless communication device 102 may extrapolate a 22 MHz WLAN channel 726. In this example, the wireless communication device 102 adds two BLE channels 728 to either side of the set 724 of contiguous interfered BLE channels 728 to construct the extrapolated WLAN channel 726. At this point, 11 BLE channels 728 are marked bad.

A BLE advertising channel 116 may be included in one of the 11 BLE channels 728 that are included within the extrapolated WLAN channel 726. The wireless communication device 102 may determine whether a BLE advertising channel 116 falls within the extrapolated WLAN channel 726 when determining a BLE scan order 114.

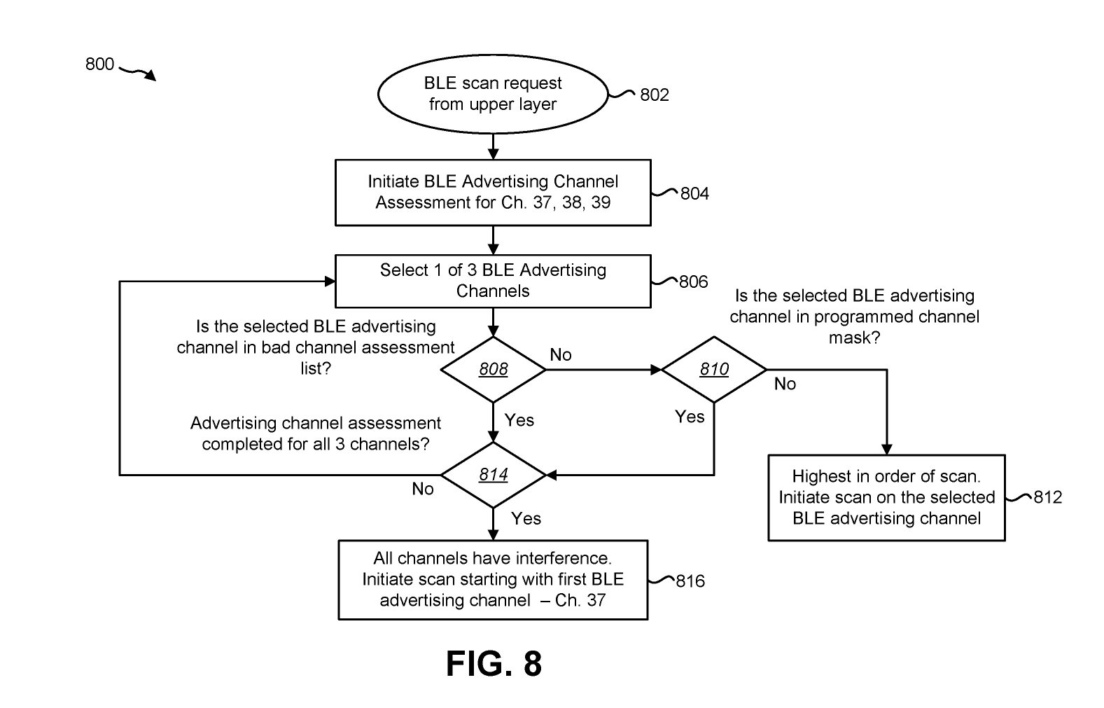

FIG. 8 is a flow diagram illustrating another configuration of a method 800 for prioritizing BLE advertising channel scanning. The method 800 may be performed by a wireless communication device 102.

The wireless communication device 102 may issue 802 a BLE scan request from an upper layer. The scan request may instruct a BLE block 110 to initiate a scan for advertising packets on BLE advertising channels 116.

The wireless communication device 102 may initiate 804 BLE advertising channel assessment for channels 37, 38 and 39. As described above, these are the channels used in BLE for transmitting and receiving advertising packets.

The wireless communication device 102 may select 806 one of the three BLE advertising channels 116 for channel assessment. For example, the wireless communication device 102 may start with channel 37. Alternatively, the wireless communication device 102 may choose one of the other BLE advertising channels 116.

The wireless communication device 102 may determine 808 whether the selected BLE advertising channel 116 is in a bad channel assessment list 122. For example, the bad channel assessment list 122 may include one or more BLE channels 328 with a detected energy (e.g., RSSI) above a bad channel threshold 120.

In an implementation, the bad channel assessment list 122 may also include BLE channels 328 that are added by a band-detect operation. For example, the wireless communication device 102 may construct an extrapolated WLAN channel 126 from a set 124 of contiguous interfered BLE channels as described in connection with FIGS. 6 and 7. BLE channels 328 that fall within the extrapolated WLAN channel 126 may be included in the bad channel assessment list 122.

If the selected BLE advertising channel 116 is not in the bad channel assessment list 122, then the wireless communication device 102 may determine 810 whether the selected BLE advertising channel 116 is in a programmed channel mask 108. The channel mask 108 may be generated by a WLAN block 106 of the wireless communication device 102. The channel mask 108 may include BLE channels 328 that overlap with a WLAN channel 432 used by the wireless communication device 102.

If the selected BLE advertising channel 116 is not in the programmed channel mask 108, then the selected BLE advertising channel 116 is assigned the highest order in the BLE scan order 114. In other words, if the wireless communication device 102 determines that a given BLE advertising channel 116 is not included in either the channel mask 108 or the bad channel assessment list 122, the wireless communication device 102 may assign a highest order in the BLE scan order 114 to the given BLE advertising channel 116. The wireless communication device 102 may initiate 812 scanning of the BLE advertising channels 116 on the selected BLE advertising channel 116.

If the wireless communication device 102 determines 808 that the selected BLE advertising channel 116 is in the bad channel assessment list 122, then the wireless communication device 102 may determine 814 whether an advertising channel assessment has been completed for all three BLE advertising channels 116. Similarly, if the wireless communication device 102 determines 810 that the selected BLE advertising channel 116 is in the programmed channel mask 108, then the wireless communication device 102 may determine 814 whether an advertising channel assessment has been completed for all three BLE advertising channels 116.

If the wireless communication device 102 has not performed an advertising channel assessment on all three BLE advertising channels 116, then the wireless communication device 102 may select 806 another BLE advertising channel 116 for channel assessment.

If the wireless communication device 102 determines 814 that advertising channel assessment has been performed on all three BLE advertising channels 116, then all BLE advertising channels 116 have interference. In other words, the wireless communication device 102 has detected interference from either the bad channel assessment or the channel mask 108. In this case, the wireless communication device 102 may initiate 816 scanning of the BLE advertising channels 116 on the first BLE advertising channel 116 (e.g., channel 37).

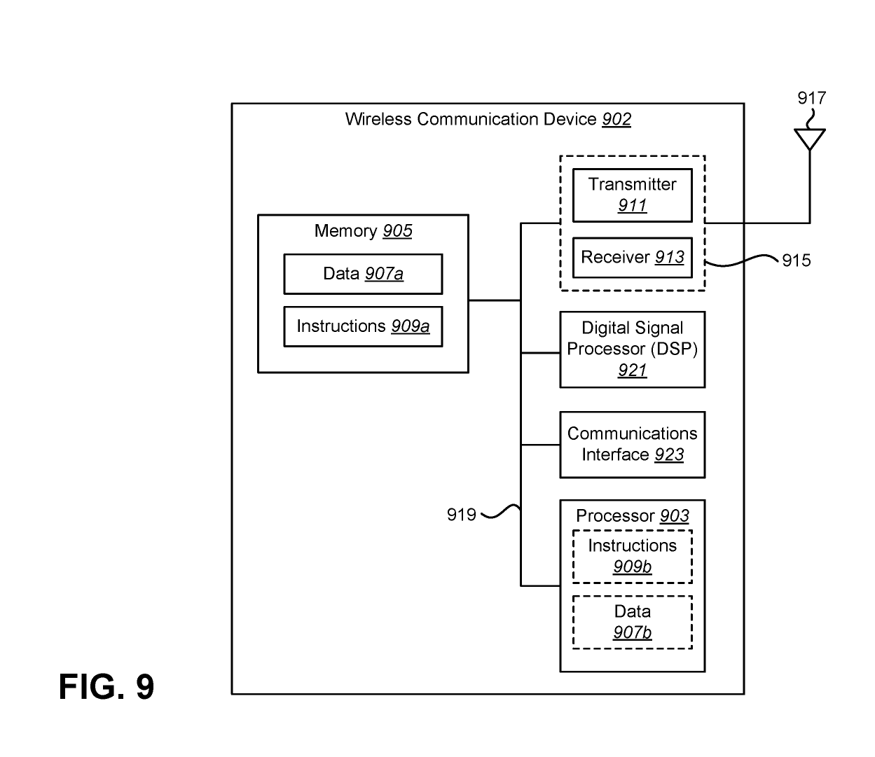

FIG. 9 illustrates certain components that may be included within a wireless communication device 902. The wireless communication device 902 described in connection with FIG. 9 may be an example of and/or may be implemented in accordance with one or more of the wireless communication device 102 described in connection with one or more of FIGS. 1-8.

The wireless communication device 902 includes a processor 903. The processor 903 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 902 of FIG. 9, in an alternative configuration, a combination of processors (e.g., an ARM and DSP) could be used.

The wireless communication device 902 also includes memory 905 in electronic communication with the processor (i.e., the processor can read information from and/or write information to the memory). The memory 905 may be any electronic component capable of storing electronic information. The memory 905 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions may include one or more programs, routines, sub-routines, functions, procedures, code, etc. The instructions may include a single computer-readable statement or many computer-readable statements. The instructions 909a may be executable by the processor 903 to implement the methods disclosed herein. Executing the instructions 909a may involve the use of the data 907a that is stored in the memory 905. When the processor 903 executes the instructions 909, various portions of the instructions 909b may be loaded onto the processor 903, and various pieces of data 907b may be loaded onto the processor 903.

The wireless communication device 902 may also include a transmitter 911 and a receiver 913 to allow transmission and reception of signals to and from the wireless communication device 902 via an antenna 917. The transmitter 911 and receiver 913 may be collectively referred to as a transceiver 915. The wireless communication device 902 may also include (not shown) multiplier transmitters, multiplier antennas, multiplier receivers and/or multiplier transceivers.

The wireless communication device 902 may include a digital signal processor (DSP) 921. The wireless communication device 902 may also include a communications interface 923. The communications interface 923 may allow a user to interact with the wireless communication device 902.

The various components of the wireless communication device 902 may be coupled together by one or more buses, which may include a power bus, a control signal bus, a status signal bus, a data bus, etc. For the sake of clarity, the various buses are illustrated in FIG. 9 as a bus system 919.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for Bluetooth low energy (BLE) advertising channel assessment by a wireless communication device, comprising:
detecting interference on one or more of a plurality of BLE advertising channels;
determining a BLE scan order in which the BLE advertising channels are selected for scanning based on the detected interference; and
scanning the BLE advertising channels according to the determined BLE scan order.

2. The method of claim 1, wherein determining the BLE scan order comprises:
determining that a first BLE advertising channel of the BLE advertising channels has no detected interference or interference below a predetermined interference threshold; and
selecting the first BLE advertising channel to be the first channel in the BLE scan order.

3. The method of claim 1, wherein detecting the interference comprises detecting a wireless local area network (WLAN) channel that overlaps one or more of the BLE advertising channels.

4. The method of claim 1, wherein detecting the interference comprises determining whether a given BLE advertising channel is in a channel mask of BLE channels that overlap with a WLAN channel used by the wireless communication device.

5. The method of claim 1, wherein detecting the interference comprises determining whether a given BLE advertising channel has a detected energy above a predetermined threshold.

6. The method of claim 1, wherein detecting the interference comprises determining whether a BLE advertising channel is in a bad channel assessment list that includes one or more BLE channels with a detected energy above a bad channel threshold.

7. The method of claim 1, wherein detecting the interference comprises:
identifying a set of contiguous interfered BLE channels that are marked bad during a bad channel assessment;
extrapolating a WLAN channel from the set of contiguous interfered BLE channels; and
determining that a given BLE advertising channel falls within the extrapolated WLAN channel.

8. The method of claim 7, further comprising determining that the given BLE advertising channel that falls within the extrapolated WLAN channel has a detected energy below a bad channel threshold.

9. The method of claim 1, further comprising:
determining that a given BLE advertising channel is not included in either a channel mask or a bad channel assessment list; and
assigning a highest order in the BLE scan order to the given BLE advertising channel.

10. A wireless communication device configured for Bluetooth low energy (BLE) advertising channel assessment, comprising:
a processor; and
a memory in electronic communication with the processor;
wherein the processor and memory are configured to:
detect interference on one or more of a plurality of BLE advertising channels;
determine a BLE scan order in which the BLE advertising channels are selected for scanning based on the detected interference; and
scan the BLE advertising channels according to the determined BLE scan order.

11. The wireless communication device of claim 10, wherein the processor and memory are further configured to:
determine that a first BLE advertising channel of the BLE advertising channels has no detected interference or interference below a predetermined interference threshold; and
select the first BLE advertising channel to be the first channel in the BLE scan order.

12. The wireless communication device of claim 10, wherein the processor and memory are configured to determine whether a given BLE advertising channel is in a channel mask of BLE channels that overlap with a WLAN channel used by the wireless communication device.

13. The wireless communication device of claim 10, wherein the processor and memory are configured to determine whether a given BLE advertising channel has a detected energy above a predetermined threshold.

14. The wireless communication device of claim 10, wherein the processor and memory are configured to determine whether a BLE advertising channel is in a bad channel assessment list that includes one or more BLE channels with a detected energy above a bad channel threshold.

15. The wireless communication device of claim 10, wherein the processor and memory are configured to:
identify a set of contiguous interfered BLE channels that are marked bad during a bad channel assessment;
extrapolate a WLAN channel from the set of contiguous interfered BLE channels; and
determine that a given BLE advertising channel falls within the extrapolated WLAN channel.

16. The wireless communication device of claim 10, wherein the processor and memory are further configured to:
determine that a given BLE advertising channel is not included in either a channel mask or a bad channel assessment list; and
assign a highest order in the BLE scan order to the given BLE advertising channel.

17. The wireless communication device of claim 10, further comprising:
an antenna configured to intercept the one or more of the plurality of BLE advertising channels; and
a receiver configured to perform the scan of the BLE advertising channels according to the determined BLE scan order.

18. An apparatus configured for Bluetooth low energy (BLE) advertising channel assessment, comprising:
means for detecting interference on one or more of a plurality of BLE advertising channels;
means for determining a BLE scan order in which the BLE advertising channels are selected for scanning based on the detected interference; and
means for scanning the BLE advertising channels according to the determined BLE scan order.

19. The apparatus of claim 18, wherein the means for determining the BLE scan order comprise:
means for determining that a first BLE advertising channel of the BLE advertising channels has no detected interference or interference below a predetermined interference threshold; and
means for selecting the first BLE advertising channel to be the first channel in the BLE scan order.

20. The apparatus of claim 18, wherein the means for detecting the interference comprise means for determining whether a given BLE advertising channel is in a channel mask of BLE channels that overlap with a WLAN channel used by the apparatus.

21. The apparatus of claim 18, wherein the means for detecting the interference comprise means for determining whether a given BLE advertising channel has a detected energy above a predetermined threshold.

22. The apparatus of claim 18, wherein the means for detecting the interference comprise means for determining whether a BLE advertising channel is in a bad channel assessment list that includes one or more BLE channels with a detected energy above a bad channel threshold.

23. The apparatus of claim 18, wherein the means for detecting the interference comprise:
means for identifying a set of contiguous interfered BLE channels that are marked bad during a bad channel assessment;
means for extrapolating a WLAN channel from the set of contiguous interfered BLE channels; and
means for determining whether a given BLE advertising channel falls within the extrapolated WLAN channel.

24. The apparatus of claim 18, further comprising:
means for determining that a given BLE advertising channel is not included in either a channel mask or a bad channel assessment list; and
means for assigning a highest order in the BLE scan order to the given BLE advertising channel.

25. A computer-program product for Bluetooth low energy (BLE) advertising channel assessment, the computer-program product comprising a non-transitory computer-readable medium having instructions thereon, the instructions comprising:
code for causing a wireless communication device to detect interference on one or more of a plurality of BLE advertising channels;
code for causing the wireless communication device to determine a BLE scan order in which the BLE advertising channels are selected for scanning based on the detected interference; and
code for causing the wireless communication device to scan the BLE advertising channels according to the determined BLE scan order.

26. The computer-program product of claim 25, wherein the code for causing the wireless communication device to determine the BLE scan order comprises:
code for causing the wireless communication device to determine that a first BLE advertising channel of the BLE advertising channels has no detected interference or interference below a predetermined interference threshold; and
code for causing the wireless communication device to select the first BLE advertising channel to be the first channel in the BLE scan order.

27. The computer-program product of claim 25, wherein the code for causing the wireless communication device to detect the interference comprises code for causing the wireless communication device to determine whether a given BLE advertising channel is in a channel mask of BLE channels that overlap with a WLAN channel used by the wireless communication device.

28. The computer-program product of claim 25, wherein the code for causing the wireless communication device to detect the interference comprises code for causing the wireless communication device to determine whether a given BLE advertising channel has a detected energy above a predetermined threshold.

29. The computer-program product of claim 25, wherein the code for causing the wireless communication device to detect the interference comprises code for causing the wireless communication device to determine whether a BLE advertising channel is in a bad channel assessment list that includes one or more BLE channels with a detected energy above a bad channel threshold.

30. The computer-program product of claim 25, wherein the code for causing the wireless communication device to detect the interference comprises:
code for causing the wireless communication device to identify a set of contiguous interfered BLE channels that are marked bad during a bad channel assessment;
code for causing the wireless communication device to extrapolate a WLAN channel from the set of contiguous interfered BLE channels; and
code for causing the wireless communication device to determine whether a given BLE advertising channel falls within the extrapolated WLAN channel.
